(19) United States
(12) Patent Application Publication
(10) Pub. No.: US 2026/0103048 A1
(43) Pub. Date: Apr. 16, 2026

(54) IN-VEHICLE AIR CONDITIONING DEVICE

(71) Applicant: TOYOTA JIDOSHA KABUSHIKI KAISHA, Toyota-shi (JP)

(72) Inventor: Akira TSUCHIYA, Seto-shi (JP)

(73) Assignee: TOYOTA JIDOSHA KABUSHIKI KAISHA, Toyota-shi (JP)

(21) Appl. No.: 19/226,529

(22) Filed: Jun. 3, 2025

(30) Foreign Application Priority Data
Oct. 11, 2024 (JP) 2024-178612

(51) Int. Cl. B60H 1/32

(52) U.S. Cl. CPC B60H 1/3216

(57) ABSTRACT

An in-vehicle air conditioning device includes a refrigerant circuit, a first cooling liquid circuit, a second cooling liquid circuit, a housing covering the refrigerant circuit, a gas sensor inside the housing, and a controller configured to control a compressor of the refrigerant circuit. The refrigerant circuit includes a compressor, a condenser for heat dissipation, an expansion valve, and an evaporator for heat absorption, and circulates a hydrocarbon-based refrigerant. The first cooling liquid circuit includes a radiator and circulates a cooling liquid heated by the condenser of the refrigerant circuit. The second cooling liquid circuit includes a cooler core for cooling an air conditioning airflow, and circulates the cooling liquid cooled by the evaporator of the refrigerant circuit. When the controller receives a command to activate the compressor, the controller avoids activation of the compressor when the gas concentration detected by the gas sensor is higher than a predetermined concentration.

### CROSS-REFERENCE TO RELATED APPLICATION

This application claims priority to Japanese Patent Application No. 2024-178612 filed on Oct. 11, 2024. The disclosure of the above-identified application, including the specification, drawings, and claims, is incorporated by reference herein in its entirety.

### BACKGROUND

### 1. Technical Field

The present specification relates to in-vehicle air conditioning devices. More particularly, the present specification discloses an in-vehicle air conditioning device that uses a hydrocarbon-based refrigerant.

### 2. Description of Related Art

In recent years, it has been considered to use hydrocarbon-based refrigerants (HC-based refrigerants) such as propane with a low global warming potential as refrigerants for air conditioning devices. Since HC-based refrigerants are flammable, configurations for preventing refrigerant leaks beforehand, configurations for ensuring safety in the event of a refrigerant leak, etc. have been considered.

Japanese Unexamined Patent Application Publication No. 2022-135023 (JP 2022-135023 A) discloses a technique related to a cooler for cooling a fuel cell. In this technique, the cooler includes a pump that sends a cooling medium to the fuel cell, and a leak of the cooling medium is detected from power consumption of the pump.

### SUMMARY

In in-vehicle air conditioning devices that use a hydrocarbon-based refrigerant, it is desired to detect a leak of a hydrocarbon-based refrigerant from a refrigerant circuit to restrict activation of a compressor of the refrigerant circuit.

The present specification discloses an in-vehicle air conditioning device that can detect a leak of a hydrocarbon-based refrigerant from a refrigerant circuit to restrict activation of a compressor.

An in-vehicle air conditioning device disclosed in the present specification includes:
a refrigerant circuit including a compressor, a condenser for heat dissipation, an expansion valve, and an evaporator for heat absorption and configured such that a hydrocarbon-based refrigerant circulates in the refrigerant circuit;
a first cooling liquid circuit including a radiator and configured such that a cooling liquid heated by the condenser of the refrigerant circuit circulates in the first cooling liquid circuit;
a second cooling liquid circuit including a cooler core configured to cool an air conditioning airflow, and configured such that the cooling liquid cooled by the evaporator of the refrigerant circuit circulates in the second cooling liquid circuit;
a housing covering the refrigerant circuit;
a gas sensor disposed inside the housing and configured to detect a gas concentration of the refrigerant outside the refrigerant circuit; and
a controller configured to control the compressor.

The controller is configured to
when the controller receives a command to activate the compressor, avoid activation of the compressor when the gas concentration detected by the gas sensor is higher than a predetermined concentration.

In this configuration, the refrigerant circuit dissipates heat to the cooling liquid of the first cooling liquid circuit and absorbs heat from the cooling liquid of the second cooling liquid circuit. Therefore, the refrigerant circuit can be concentrated in a relatively small area and housed in the housing. If the refrigerant leaks from the refrigerant circuit, the refrigerant leak can be detected inside the housing by the gas sensor. In this case, activation of the compressor can be avoided when the gas concentration detected by the gas sensor is higher than the predetermined concentration.

In the in-vehicle air conditioning device of the present disclosure, the predetermined concentration may be a second concentration, and
a first concentration lower than the second concentration may be determined in advance.

The controller may be configured to
when the controller receives the command to activate the compressor, activate the compressor when the gas concentration detected by the gas sensor is lower than the first concentration.

With this configuration, the compressor can be activated inside the housing where safety has been confirmed by the gas sensor.

The in-vehicle air conditioning device of the present disclosure may further include:
an internal temperature sensor configured to detect an internal temperature of the refrigerant circuit; and
an external temperature sensor configured to detect an external temperature of the refrigerant circuit.

The controller may be configured to
when the controller receives the command to activate the compressor, and the gas concentration detected by the gas sensor is higher than or equal to the first concentration and lower than or equal to the second concentration,
avoid the activation of the compressor when the temperature detected by the internal temperature sensor is lower than a temperature threshold, and activate the compressor when the temperature detected by the internal temperature sensor is higher than or equal to the temperature threshold. The temperature threshold is a value obtained by subtracting a predetermined temperature from the temperature detected by the external temperature sensor.

With this configuration, when the gas concentration detected by the gas sensor is higher than or equal to the first concentration and lower than or equal to the second concentration, the presence or absence of a refrigerant leak is also checked, and activation of the compressor can be avoided according the check result. When there is a refrigerant leak from the refrigerant circuit, the leaked refrigerant absorbs heat as it evaporates. Therefore, the internal temperature of the refrigerant circuit becomes lower than the external temperature of the refrigerant circuit. In the above configuration, when the internal temperature of the refrigerant circuit is lower than the temperature threshold, namely the value obtained by subtracting the predetermined temperature from the external temperature of the refrigerant circuit, it is determined that there is a possibility of a refrigerant leak, and activation of the compressor can be avoided.

The in-vehicle air conditioning device of the present disclosure may further include:
an internal pressure sensor configured to detect an internal pressure of the refrigerant circuit;
an external temperature sensor configured to detect an external temperature of the refrigerant circuit; and
a storage device storing a table representing a saturated vapor pressure curve of the refrigerant.

The controller may be configured to acquire, by using the table of the saturated vapor pressure curve, a pressure of the refrigerant corresponding to the temperature detected by the external temperature sensor as an expected pressure.

The controller may be configured to
when the controller receives the command to activate the compressor, and the gas concentration detected by the gas sensor is higher than or equal to the first concentration and lower than or equal to the second concentration,
avoid the activation of the compressor when the pressure detected by the internal pressure sensor is lower than a pressure threshold, and activate the compressor when the pressure detected by the internal pressure sensor is higher than or equal to the pressure threshold. The pressure threshold is a value obtained by subtracting a predetermined pressure from the expected pressure.

With this configuration as well, when the gas concentration detected by the gas sensor is higher than or equal to the first concentration and lower than or equal to the second concentration, the presence or absence of a refrigerant leak is also checked, and activation of the compressor can be avoided according the check result. Before the compressor is activated, the refrigerant inside the refrigerant circuit is at liquid-vapor equilibrium. Therefore, the relationship between the temperature and the pressure of the refrigerant in the refrigerant circuit follows the saturated vapor pressure curve of the refrigerant. Before the compressor is activated, the internal temperature and the external temperature of the refrigerant circuit are the same or close to each other. Therefore, the internal pressure of the refrigerant circuit can be estimated from the external temperature of the refrigerant circuit (estimated value of the internal temperature of the refrigerant circuit) by using the saturated vapor pressure curve of the refrigerant circuit. This estimated internal pressure (called the expected pressure) is the internal pressure of the refrigerant circuit when there is no refrigerant leak from the refrigerant circuit. On the other hand, when there is a refrigerant leak from the refrigerant circuit, the internal pressure of the refrigerant circuit is lower than the expected pressure. In the above configuration, the presence or absence of a refrigerant leak is checked using this principle. Specifically, in the above configuration, the pressure detected by the internal pressure sensor configured to detect the internal pressure of the refrigerant circuit may be lower than the pressure threshold that is the value obtained by subtracting the predetermined pressure from the expected pressure. In this case, it is determined that there is a possibility of a refrigerant leak, and activation of the compressor can be avoided.

In the in-vehicle air conditioning device of the present disclosure, the controller may be configured to
stop the compressor when the gas concentration detected by the gas sensor increases and the rate of increase in the gas concentration per unit time becomes higher than a predetermined rate of increase while the compressor is in operation after the compressor is activated.

With this configuration, if the refrigerant leaks from the refrigerant circuit, the compressor can be stopped before the refrigerant gas concentration inside the housing increases.

In the in-vehicle air conditioning device of the present disclosure, the hydrocarbon-based refrigerant may be propane or a refrigerant mainly containing propane.

A vehicle disclosed in the present specification includes the in-vehicle air conditioning device described above.

The technique disclosed in the present specification can detect a leak of a hydrocarbon-based refrigerant from a refrigerant circuit to restrict activation of a compressor.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a configuration of an air conditioning device;

FIG. 2 is a perspective view showing a refrigerant module;

FIG. 3 is a block diagram illustrating a configuration of an air conditioning device;

FIG. 4 is a flowchart showing activation control of the compressor;

FIG. 5 is a flowchart illustrating another activation control of the compressor;

FIG. 6 is a flowchart showing control during operation of the compressor; and

FIG. 7 is a diagram illustrating a saturated vapor pressure curve of a refrigerant.

### DETAILED DESCRIPTION OF EMBODIMENTS

### Introduction

Hereinafter, embodiments will be described with reference to the drawings. In all the drawings, equivalent elements are denoted by the same reference numerals, and redundant description is omitted.

The air conditioning device is mounted on a vehicle such as an automobile. In the embodiments described below, the type of the vehicle on which the air conditioning device is mounted is not limited. For example, the vehicle may be an engine vehicle using an engine as a power source, or a battery electric vehicle using a motor as a power source. The vehicles may also be a hybrid battery electric vehicle or a plug-in hybrid battery electric vehicle equipped with both an engine and a motor. In addition, the vehicles may be a fuel cell electric vehicle equipped with fuel cells, or may be a battery electric vehicle that runs with electric power stored in a battery.

The air conditioning device includes a refrigerant circuit in which a hydrocarbon-based refrigerant (referred to as an HC-based refrigerant) circulates. HC-based refrigerants are flammable. Examples of HC-based refrigerants include propane, butane, isobutane, ethane, ethylene, and propylene. In the refrigerant circuit, a refrigerant obtained by mixing one of these HC-based refrigerants or two or more of these HC-based refrigerants may be used. In the refrigerant circuit, a mixed refrigerant mainly containing one or more kinds of HC-based refrigerants and further containing a refrigerant other than HC-based refrigerants, various additives, etc. may be used. For example, in the refrigerant circuit, propane or a refrigerant mainly containing propane and further containing at least one of another refrigerant and an additive (refrigerant mainly containing propane) may be used. HC-based refrigerant may be R290 as an example. In the present specification, the hydrocarbon-based refrigerant means a pure hydrocarbon-based refrigerant or a refrigerant mainly containing a hydrocarbon-based refrigerant.

The refrigerant circuit serves as a heat source of the air conditioning device. The refrigerant circuit includes, in order along the flow direction of the refrigerant, a compressor, a condenser for heat dissipation, an expansion valve, and an evaporator for heat absorption. A receiver may be provided between the condenser and the expansion valve. An accumulator may be provided between the evaporator and the compressor.

The air conditioning device may include a high-temperature cooling liquid circuit in which the cooling liquid heated by the condenser of the refrigerant circuit circulates, and a low-temperature cooling liquid circuit in which the cooling liquid cooled by the evaporator of the refrigerant circuit circulates. The cooling liquid is a heat medium, and the high-temperature cooling liquid circuit and the low-temperature cooling liquid circuit are each a heat medium circuit.

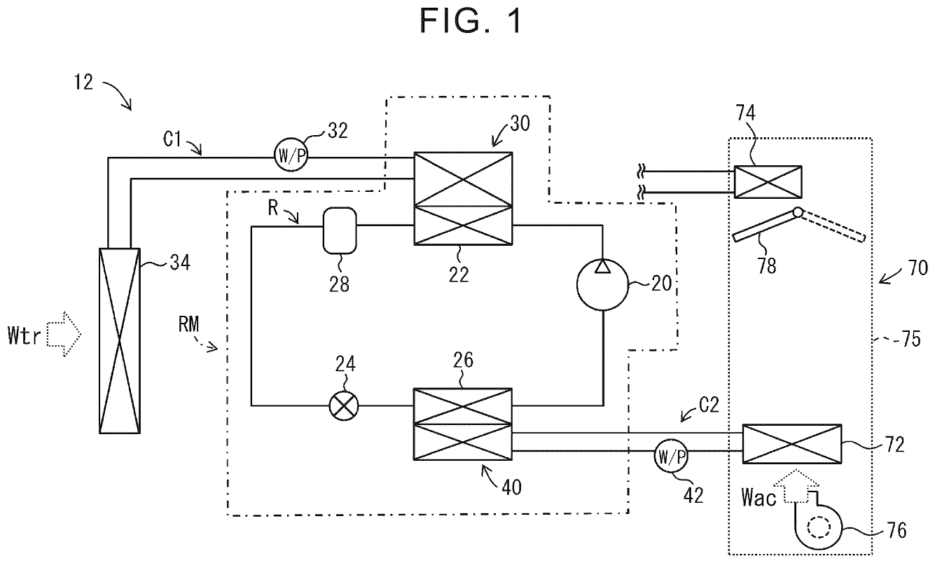

In the embodiment described below, as shown in FIG. 1, the air conditioning device 12 includes a first cooling liquid circuit C1 as a high-temperature cooling liquid circuit and a second cooling liquid circuit C2 as a low-temperature cooling liquid circuit. The cooling liquid of the first and second cooling liquid circuits C1, C2 may be coolant. That is, the cooling liquid may be water containing no additive, water containing an additive such as an antifreeze agent or an antiseptic, or a coolant liquid. Further, a liquid heat medium such as oil may be employed as the cooling liquid, and is not limited thereto.

In the embodiments described below, the refrigerant circuit is located below the front hood of the vehicle. Hereinafter, the area under the front hood is referred to as an “engine compartment” regardless of the presence or absence of a power source (engine, motor, etc.) under the front hood and the type of the power source.

### Embodiments

FIG. 1 is a schematic diagram illustrating a configuration of an air conditioning device 12 according to an embodiment. The air conditioning device 12 performs air conditioning in the interior of the vehicle. As shown in FIG. 1, the air conditioning device 12 includes a refrigerant circuit R serving as a heat source, a first cooling liquid circuit C1, a second cooling liquid circuit C2, and an air conditioning unit 70. In the first cooling liquid circuit C1, the first cooling liquid heated by the refrigerant in the refrigerant circuit R circulates. In the second cooling liquid circuit C2, the second cooling liquid cooled by the refrigerant in the refrigerant circuit R circulates. The air conditioning unit 70 supplies the air cooled by the second cooling liquid circulating in the second cooling liquid circuit C2 to the vehicle cabin.

The refrigerant circuit R is a closed circuit in which the compressor 20, the condenser 22, the receiver 28, the expansion valve 24, and the evaporator 26 are sequentially connected by a refrigerant pipe (refrigerant channel), and the hydrocarbon-based refrigerant (hereinafter, also simply referred to as refrigerant) is circulated.

The air conditioning device 12 includes a heat exchanger 30. The heat exchanger 30 is integrated with the condenser 22 of the refrigerant circuit R, and exchanges heat between the refrigerant of the refrigerant circuit R and the first cooling liquid of the first cooling liquid circuit C1. The heat exchanger 30 is a water-cooled condenser. The heat exchanger 30 may be, for example, a plate heat exchanger.

The first cooling liquid circuit C1 is a closed circuit in which the water pump 32, the heat exchanger 30, and the radiator 34 are sequentially connected by cooling liquid pipes to circulate the first cooling liquid. The radiator 34 is a heat exchanger that exchanges heat between the first cooling liquid and the vehicle traveling wind Wtr. In the first cooling liquid circuit C1, the first cooling liquid pumped by the water pump 32 is heated to a high temperature by the heat dissipation of the refrigerant in the condenser 22 in the refrigerant circuit R while passing through the heat exchanger 30. The high-temperature first cooling liquid is sent to the radiator 34, where it is cooled by the vehicle traveling wind Wtr.

Further, the air conditioning device 12 includes a heat exchanger 40. The heat exchanger 40 is integrated with the evaporator 26 of the refrigerant circuit R, and exchanges heat between the refrigerant of the refrigerant circuit R and the second cooling liquid of the second cooling liquid circuit C2. The heat exchanger 40 may be, for example, a plate heat exchanger.

The second cooling liquid circuit C2 is a closed circuit in which the water pump 42, the heat exchanger 40, and the cooler core 72 are sequentially connected by cooling liquid pipes to circulate the second cooling liquid. The cooler core 72 is a heat exchanger that is disposed in the air passage 75 of the air conditioning unit 70 and exchanges heat between the second cooling liquid and the air conditioning airflow Wac. In the second cooling liquid circuit C2, the second cooling liquid pumped by the water pump 42 becomes a low temperature due to the heat absorption of the refrigerant in the evaporator 26 in the refrigerant circuit R while passing through the heat exchanger 40. The second cooling liquid having reached the low temperature is sent to the cooler core 72, where it cools the air conditioning airflow Wac.

In the refrigerant circuit R, the refrigerant circulates as follows. Compressor 20 discharges a high-pressure gas refrigerant, the gas refrigerant is liquefied condensed by heat exchange with the first cooling liquid of the first cooling liquid circuit C1 passing through the heat exchanger 30 in the condenser 22, and becomes a high-pressure liquid refrigerant. The high-pressure liquid refrigerant flowing out of the condenser 22 is decompressed and expanded by the expansion valve 24 via the receiver 28, becomes a low-pressure refrigerant, and flows into the evaporator 26. The low-pressure refrigerant flowing into the evaporator 26 is evaporated by heat exchange with the second cooling liquid in the second cooling liquid circuit C2 passing through the heat exchanger 40 in the evaporator 26, becomes a gaseous refrigerant, flows out the evaporator 26, and returns to the compressor 20.

The air conditioning unit 70 includes a blower 76 and an air passage 75 formed by a case, not shown. In the air passage 75, a blower 76, a cooler core 72, and a heater core 74 are arranged in this order from the air flow direction. The heater core 74 is, for example, a heat exchanger to which engine coolant or coolant warmed by a water-heating PTC heater is supplied. The heater core 74 may be configured to supply the cooling liquid warmed by the heat exchanger 30.

The blower 76 introduces air into the air passage 75 from an intake port, not shown, and allows the air to be passed through the cooler core 72 and the heater core 74, thereby blowing the temperature-controlled air into the vehicle cabin. An air mix door 78 is provided inside the air passage 75, and the air mix door 78 adjusts a ratio at which the air that has passed through the cooler core 72 flows to the heater core 74. Note that the air conditioning unit 70 may employ a conventional technique of HVAC (Heating, Ventilation, and Air Conditioning). The air conditioning unit 70 is disposed, for example, between an instrument panel and a dashboard of the vehicle.

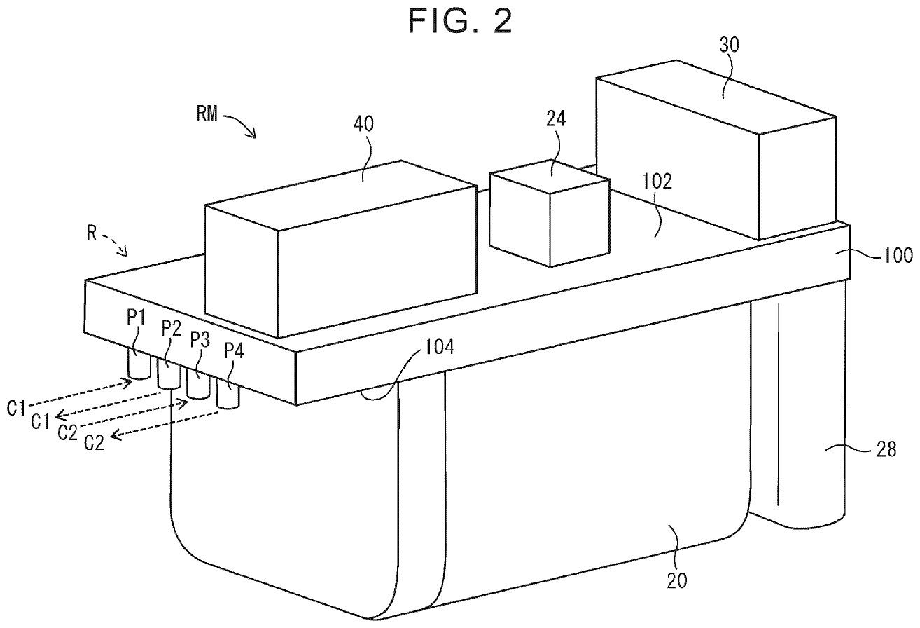

FIG. 2 is a perspective view illustrating a refrigerant module RM. The refrigerant circuit R is integrated to form a refrigerant module RM. Specifically, the refrigerant module RM is a unit of the air conditioning device 12 in which a device and a channel inside the long dashed short dashed line in FIG. 1 are integrated.

As shown in FIG. 2, the refrigerant module RM includes a plate 100. The plate 100 is a fixed member to which a plurality of devices is fixed. The plate 100 has a rectangular shape in a top view and has a constant thickness. The plate 100 may be made of, for example, aluminum. The heat exchanger 30, the expansion valve 24, and the heat exchanger 40 are fixed to the upper surface 102 of the plate 100. The compressor 20 and the receiver 28 are fixed to the lower surface 104 of the plate 100.

A channel (not shown) is provided in the plate 100 in the form of a tunnel. Specifically, inside the plate 100, a refrigerant channel of the refrigerant circuit R, a cooling liquid channel of part of the first cooling liquid circuit C1 (channel of the first cooling liquid that communicates with the heat exchanger 30), and a cooling liquid channel of part of the second cooling liquid circuit C2 (channel of the second cooling liquid that communicates with the heat exchanger 40) are provided. Note that the refrigerant module RM may include a pipe or a component for at least one of the refrigerant channel and the cooling liquid channel on the outer side of the plate 100 in addition to or instead of the channel inside the plate 100.

As shown in FIG. 2, the refrigerant module RM includes ports P1 to P4. The ports P1 to P4 are provided on the lower surface of the end portion of the plate 100 on one side in the longitudinal direction. The ports P1, P2 communicate with the channel of the first cooling liquid inside the plate 100, and the piping of the first cooling liquid circuit C1 is connected. The ports P3, P4 communicate with the channel of the second cooling liquid inside the plate 100, and the piping of the second cooling liquid circuit C2 is connected.

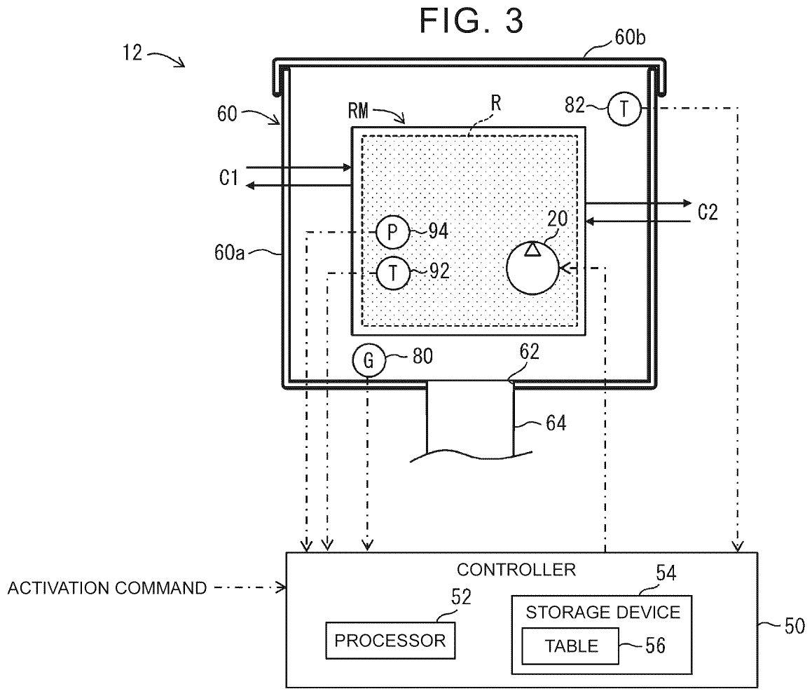

FIG. 3 is a block diagram showing a configuration of the air conditioning device 12, and schematically shows a cross section of the housing 60. The air conditioning device 12 includes a housing 60. The housing 60 includes a housing body 60a and a lid 60b. The refrigerant module RM is housed in the housing 60. The lid 60b is removed from the housing body 60a, the refrigerant module RM is housed in the housing body 60a, and then the lid 60b is attached to the housing body 60a. The refrigerant module RM is fixed to the inner surface of the housing body 60a via brackets (not shown). The pipes of the first and second cooling liquid circuits C1, C2 pass through the side plates of the housing body 60a, and are connected to P4 (see FIG. 2) from the port P1 of the refrigerant module RM.

The upper surface of the lid 60b may have one or more openings. In addition, the housing 60 may be configured without the lid 60b.

The housing 60 and the refrigerant module RM are arranged in the engine compartment of the vehicle. As shown in FIG. 3, the bottom plate of the housing body 60a includes a hole 62. A hose 64 extending downward of the vehicle is connected to the hole 62. The hose 64 extends from the hole 62 of the bottom plate toward the bottom of the vehicle body. A distal end (not shown) of the hose 64 may be secured to a vehicle body structure located at a lower portion (or bottom) of the engine compartment.

With this hose 64, when the refrigerant leaks from the refrigerant circuit R, the refrigerant can be guided to the vehicle lower side through the hose 64. The refrigerant (HC-based refrigerant) is generally heavier than air, and therefore flows downward through the hose 64. This allows the refrigerant to be discharged to a relatively safe location at the bottom of the vehicle body.

The air conditioning device 12 includes a gas sensor 80. The gas sensor 80 is disposed in the housing 60 and detects the gas concentration of the refrigerant outside the refrigerant circuit R. The gas sensor 80 is provided, for example, at a position close to the bottom of the housing 60.

The air conditioning device 12 includes an external temperature sensor 82, an internal temperature sensor 92, and an internal pressure sensor 94.

The external temperature sensor 82 is a temperature sensor that detects an external temperature of the refrigerant circuit R. The external temperature sensor 82 may be provided at a position where the refrigerant does not flow when the refrigerant leaks from the refrigerant circuit R. That is, the external temperature sensor 82, when the refrigerant leaks from the refrigerant circuit R, rather than the air temperature is lowered by the refrigerant is vaporized, it may be provided at a position capable of detecting the temperature of the air that is not affected by the refrigerant. The refrigerant (HC-based refrigerant) is generally heavier than air, and therefore flows downward in the housing 60. Therefore, the external temperature sensor 82 may be provided above the refrigerant circuit R in the housing 60, for example, as shown in FIG. 3, or above the lower end of the refrigerant circuit R. In addition, a partition wall that separates the refrigerant circuit R and the external temperature sensor 82 may be provided in the housing 60. In addition, an inner wall forming a closed space in which the external temperature sensor 82 is disposed may be provided in the housing 60. The external temperature sensor 82 may be provided outside the housing 60.

The internal temperature sensor 92 is a temperature sensor that detects the internal temperature of the refrigerant circuit R. The internal temperature sensor 92 detects, for example, a temperature in the refrigerant pipe. The internal pressure sensor 94 is a pressure sensor that detects the internal pressure of the refrigerant circuit R. The internal pressure sensor 94 detects, for example, a pressure in the refrigerant pipe.

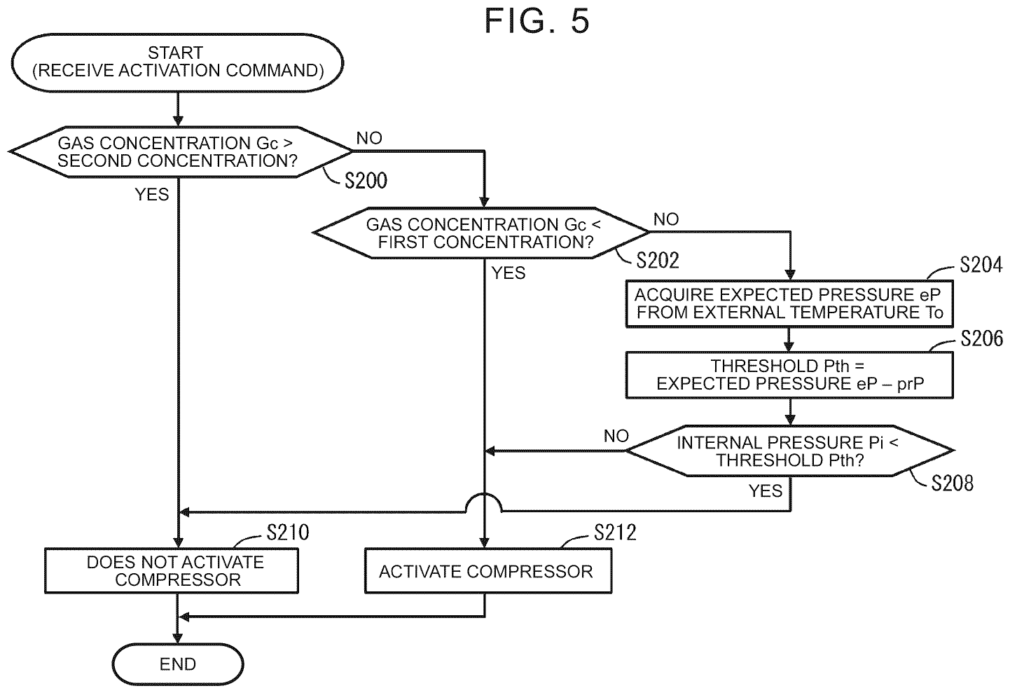

The air conditioning device 12 includes a controller 50. The controller 50 may be configured to include a microcomputer, and may be, for example, an ECU (Electronic Control Unit). The controller 50 includes a processor 52 and a storage device 54. The processor 52 includes a CPU (Central Processing Unit), and CPU operates in accordance with programs and control data stored in the storage device 54 to execute various operations and controls. The storage device 54 may include a ROM (Read Only Memory), a RAM (Random Access Memory), flash memory, and the like. The storage device 54 stores a table 56 representing a saturated vapor pressure curve of the refrigerant. This table 56 is used in the embodiment described with reference to FIG. 5.

The controller 50 controls the compressor 20 of the refrigerant circuit R. The controller 50 receives the detected gas concentration from the gas sensor 80, the detected temperature from the external temperature sensor 82, the detected temperature from the internal temperature sensor 92, and the detected pressure from the internal pressure sensor 94.

A command to activate the compressor 20 is input to the controller 50. This activation command is a command to start the operation of the compressor 20. For example, when the user turns on the air conditioning device 12 from off using an operation panel (not shown), the command to activate the compressor 20 is transmitted from the operation panel or an ECU or the like connected to the operation panel. In addition, the command to activate the compressor 20 may be transmitted from the computer when the air conditioning device 12 automatically operates using a computer such as an ECU (operates in an auto mode).

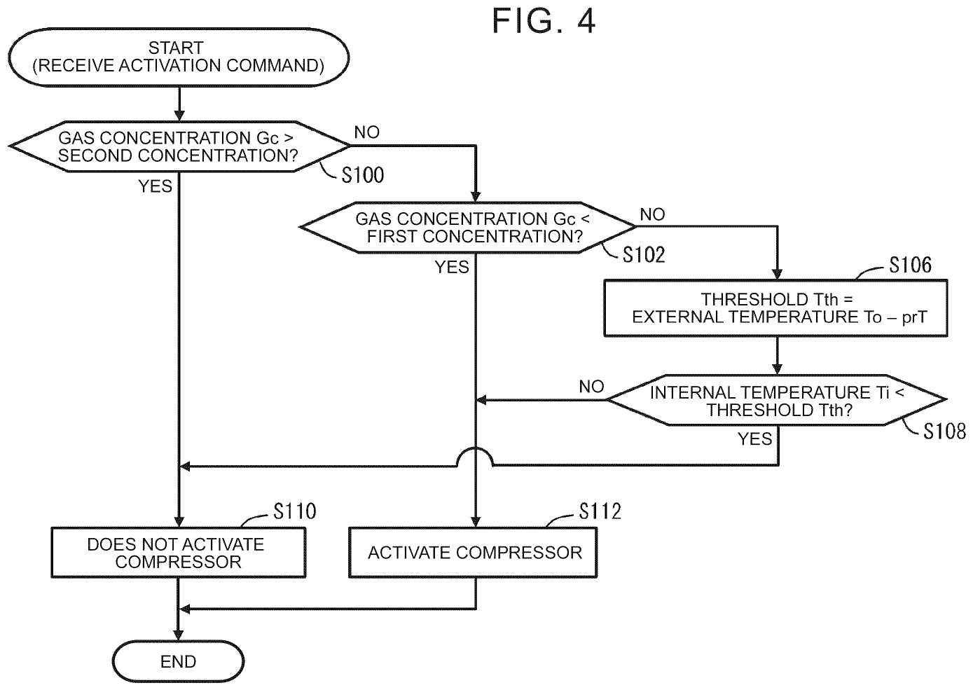

FIG. 4 is a flowchart showing activation control of the compressor 20. The controller 50 executes the control of FIG. 4 when receiving the command activate the compressor 20. In this control, the internal pressure sensor 94 and the table 56 are not used.

In S100, the controller 50 checks whether the detected gas concentration Gc from the gas sensor 80 is higher than a predetermined second concentration. This second concentration is stored in advance in the storage device 54. The second concentration is a gas concentration of the refrigerant set in consideration of safety.

When the detected gas concentration Gc from the gas sensor 80 is higher than the second concentration (S100: Yes), the controller 50 proceeds to S110. In S110, the controller 50 does not activate the compressor 20. That is, the controller 50 keeps the compressor 20 stopped.

On the other hand, when the detected gas concentration Gc from the gas sensor 80 is lower than or equal to the second concentration (S100: No), the controller 50 proceeds to S102. In S102, the controller 50 checks whether the detected gas concentration Gc from the gas sensor 80 is lower than a predetermined first concentration. This first concentration is stored in advance in the storage device 54. This first concentration is a gaseous concentration that is lower than the second concentration of S100. The first concentration is a gas concentration of the refrigerant set in consideration of safety.

When the detected gas concentration Gc from the gas sensor 80 is lower than the first concentration (S102: Yes), the controller 50 proceeds to S112. In S112, the controller 50 activates the compressor 20. That is, the controller 50 starts the operation of the compressor 20.

On the other hand, when the detected gas concentration Gc from the gas sensor 80 is higher than or equal to the first concentration (S102: No), the controller 50 proceeds to S106. In S106, the controller 50 calculates a temperature threshold Tth obtained by subtracting a predetermined temperature prT from the detected temperature To from the external temperature sensor 82. The predetermined thermal prT is stored in the storage device 54 in advance.

Next, in S108, the controller 50 checks whether the detected temperature Ti from the internal temperature sensor 92 is lower than the temperature threshold Tth calculated by S106. When the detected temperature Ti from the internal temperature sensor 92 is lower than the temperature threshold Tth (S108: Yes), the controller 50 proceeds to S110. In S110, the controller 50 does not activate the compressor 20. That is, the controller 50 keeps the compressor 20 stopped.

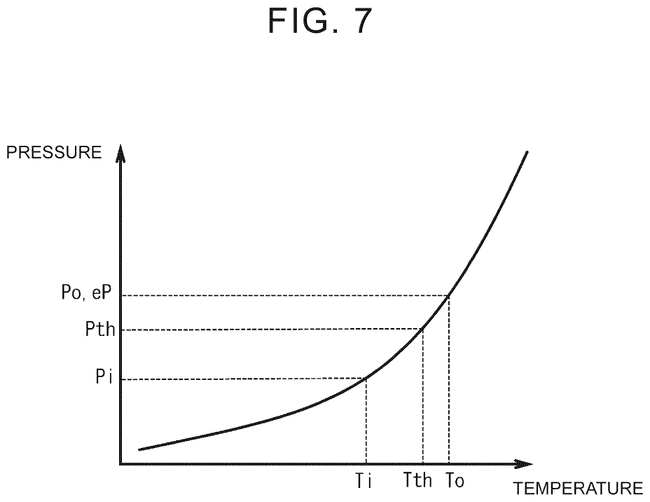

FIG. 7 is a diagram illustrating a saturated vapor pressure curve of a refrigerant. In this activation control, the saturated vapor pressure curve of the refrigerant is not used, but when attention is paid to the “temperature” on the horizontal axis of FIG. 7, the horizontal axis shows an exemplary relation between the “detected temperature To of the external temperature sensor 82”, the “detected temperature Ti from the internal temperature sensor 92”, and the “temperature threshold Tth” when the condition that S108 of FIG. 4 is Yes is satisfied.

On the other hand, in S108 of FIG. 4, when the detected temperature Ti from the internal temperature sensor 92 is higher than or equal to the temperature threshold Tth (S108: No), the controller 50 proceeds to S112. In S112, the controller 50 activates the compressor 20.

According to the embodiment described above, the refrigerant circuit R radiates heat to the first cooling liquid in the first cooling liquid circuit C1 and absorbs heat from the second cooling liquid in the second cooling liquid circuit C2. Therefore, as shown in FIG. 3, the refrigerant circuit R can be concentrated in a relatively small area and housed in the housing 60. When the refrigerant leaks from the refrigerant circuit R, the refrigerant can be detected by the gas sensor 80 in the housing 60. At this time, when the detected gas concentration Gc from the gas sensor 80 is higher than the predetermined second concentration (S100: Yes in FIG. 4), activation of the compressor 20 can be avoided (S110).

According to the embodiment described above, when the detected gas concentration Gc from the gas sensor 80 is lower than the first concentration that is lower than the second concentration (S102: Yes), the compressor 20 is activated (S112). Therefore, the compressor 20 can be activated in the housing 60 where safety is confirmed by the gas sensor 80.

According to the embodiment described above, when the detected gas concentration Gc from the gas sensor 80 is higher than or equal to the first concentration and lower than or equal to the second concentration (S102: No), the presence or absence of a refrigerant leak is also checked, and activation of the compressor 20 can be avoided according the check result. When there is a refrigerant leak from the refrigerant circuit R, the leaked refrigerant absorbs heat as it evaporates. Therefore, the internal temperature Ti of the refrigerant circuit R becomes lower than the external temperature To of the refrigerant circuit R. According to the embodiment described above, the internal temperature Ti of the refrigerant circuit R may be lower than the temperature threshold Tth obtained by subtracting the predetermined temperature prT from the external temperature To of the refrigerant circuit R (S108: Yes). In this case, it may be determined that there is a possibility of a refrigerant leak, and activation of the compressor 20 may be avoided (S110).

In another embodiment, when the controller 50 receives the command to activate the compressor 20, the detected gas concentration Gc from the gas sensor 80 may be higher than a predetermined concentration (for example, the above second concentration). This may be done by avoiding activation of the compressor 20 and activating the compressor 20 otherwise (when the detected gas concentration Gc is lower than or equal to the predetermined concentration).

### Another Activation Control

FIG. 5 is a flowchart illustrating another activation control of the compressor 20. The controller 50 executes the control of FIG. 5 when receiving the command to activate the compressor 20. In this control, the internal temperature sensor 92 is not used.

S200 and S202 in FIG. 5 are the same determinations as S100 and S102 in FIG. 4, and S210 and S212 in FIG. 5 corresponding to the determinations are also the same processes as S110 and S112 in FIG. 4. Therefore, explanations of S200 and S202 in FIG. 5 are omitted.

S204 is a process when No is determined in S202. That is, S204 is a process when the detected gas concentration Gc from the gas sensor 80 is higher than or equal to the first concentration and lower than or equal to the second concentration. In S204, the controller 50 uses the table 56 of the saturated vapor pressure curve of the refrigerant to acquire the pressure of the refrigerant corresponding to the detected temperature To from the external temperature sensor 82 as the expected pressure eP. The table 56 is stored in advance in the storage device 54.

FIG. 7 is a diagram illustrating a saturated vapor pressure curve of a refrigerant. The saturated vapor pressure curve indicates the relationship between the temperature and the pressure of the refrigerant in the refrigerant circuit R when the refrigerant in the refrigerant circuit R is at liquid-vapor equilibrium, that is, when the compressor 20 is not operating. In FIG. 7, the pressure of the refrigerant corresponding to the detected temperature To from the external temperature sensor 82 is indicated by reference numeral Po (expected pressure eP). The controller 50 obtains the expected pressure eP (Po) corresponding to the external temperature To from the table 56 of the saturated vapor pressure curve.

In S206 of FIG. 5, the controller 50 calculates the pressure threshold Pth by subtracting the predetermined pressure prP from the expected pressure eP. The predetermined pressure prP is stored in the storage device 54 in advance.

Next, in S208, the controller 50 checks whether the detected pressure Pi from the internal pressure sensor 94 is lower than the pressure threshold Pth calculated in S206. When the detected pressure Pi from the internal pressure sensor 94 is lower than the pressure threshold Pth (S208: Yes), the controller 50 proceeds to S210. In S210, the controller 50 does not activate the compressor 20. That is, the controller 50 keeps the compressor 20 stopped.

FIG. 7 shows an example of the relationship among the “expected pressure eP”, the “detected pressure Pi from the internal pressure sensor 94”, and the “pressure threshold Pth” when S208 of FIG. 5 is Yes.

On the other hand, in S208 of FIG. 5, when the detected pressure Pi from the internal pressure sensor 94 is higher than or equal to the pressure threshold Pth (S208: No), the controller 50 proceeds to S212. In S212, the controller 50 activates the compressor 20.

Also in the other activation control described above, when the detected gas concentration from the gas sensor 80 is higher than or equal to the first concentration and lower than or equal to the second concentration (S202: No), the presence or absence of a refrigerant leak is also checked, and activation of the compressor 20 can be avoided according to the check result.

Before the compressor 20 is activated, the refrigerant inside the refrigerant circuit R is at liquid-vapor equilibrium. Therefore, the relationship between the temperature and the pressure of the refrigerant in the refrigerant circuit R follows the saturated vapor pressure curve of the refrigerant. Before the compressor 20 is activated, the internal temperature Ti and the external temperature To of the refrigerant circuit R is the same or close to each other when there is no refrigerant leak from the refrigerant circuit R. Therefore, it is possible to estimate the internal pressure Pi of the refrigerant circuit R from the external temperature To of the refrigerant circuit R (the estimated value of the internal temperature Ti of the refrigerant circuit R) using the saturated vapor pressure curve. The estimated internal pressure Pi is the expected pressure eP and is the internal pressure Pi of the refrigerant circuit R when there is no refrigerant leak from the refrigerant circuit R. On the other hand, when there is a refrigerant leak in the refrigerant circuit R, the internal pressure Pi of the refrigerant circuit R is lower than the expected pressure eP. In the above activation control, the presence or absence of a refrigerant leak is checked using this principle. Specifically, according to the above activation control, the detected pressure Pi from the internal pressure sensor 94 that detects the internal pressure of the refrigerant circuit R may be lower than the pressure threshold Pth obtained by subtracting the predetermined pressure prP from the expected pressure eP (S208: Yes). In this case, it is determined that there is a possibility of a refrigerant leak, and activation of the compressor 20 can be avoided (S210).

### Control During Operation of Compressor

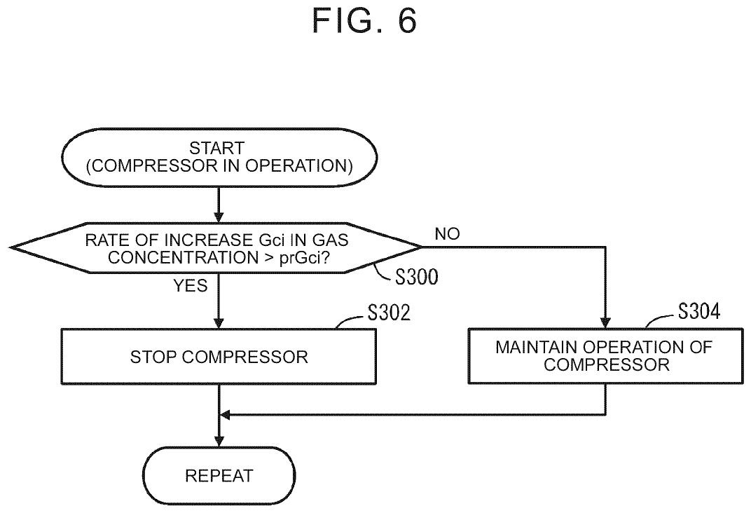

FIG. 6 is a flowchart illustrating control during operation of the compressor 20. The controller 50 may execute the control of FIG. 6 after activating the compressor 20 by the activation control of FIG. 4 or 5 or the general activation control. The control of FIG. 6 is repeatedly executed at a predetermined cycle.

In S300, the controller 50 checks whether the detected gas concentration Gc from the gas sensor 80 increases and the rate of increase Gci in the detected gas concentration Gc per unit time is higher than a predetermined rate of increase prGci. The unit time may be, for example, one second, 10 seconds, 30 seconds, 60 seconds, 120 seconds, 180 seconds, etc. The rate of increase Gci is an increase in the gas concentration G in per unit time. The predetermined rate of increase prGci is stored in the storage device 54 in advance.

When the rate of increase Gci in the detected gas concentration Gc per unit time is higher than the predetermined rate of increase prGci (S300: Yes), the controller 50 stops the compressor 20. On the other hand, the controller 50 maintains the operation of the compressor 20 when there is no increase in the detected gas concentration Gc or when the rate of increase Gci in the detected gas concentration Gc per unit time is lower than or equal to the predetermined rate of increase prGci (S300: No).

According to this control, when the refrigerant leaks from the refrigerant circuit R, the compressor 20 can be stopped before the refrigerant gas concentration inside the housing 60 increases.

In another embodiment, the controller 50 monitors the detected gas concentration Gc from the gas sensor 80 at a predetermined cycle while the compressor 20 is in operation, and the detected gas concentration Gc may be higher than a predetermined concentration (e.g., the second concentration described above). In this case, the compressor 20 may be stopped, and if not (when the detected gas concentration Gc is lower than or equal to the predetermined concentration), the operation of the compressor 20 may be maintained.

What is claimed is:

1. An in-vehicle air conditioning device comprising:
a refrigerant circuit including a compressor, a condenser for heat dissipation, an expansion valve, and an evaporator for heat absorption, the refrigerant circuit being configured such that a hydrocarbon-based refrigerant circulates in the refrigerant circuit;
a first cooling liquid circuit including a radiator, the first cooling liquid circuit being configured such that a cooling liquid heated by the condenser of the refrigerant circuit circulates in the first cooling liquid circuit;
a second cooling liquid circuit including a cooler core configured to cool an air conditioning airflow, the second cooling liquid circuit being configured such that the cooling liquid cooled by the evaporator of the refrigerant circuit circulates in the second cooling liquid circuit;
a housing covering the refrigerant circuit;
a gas sensor disposed inside the housing, the gas sensor being configured to detect a gas concentration of the refrigerant outside the refrigerant circuit; and
a controller configured to control the compressor,
wherein the controller is configured to, when the controller receives a command to activate the compressor, avoid activation of the compressor when the gas concentration detected by the gas sensor is higher than a predetermined concentration.

2. The in-vehicle air conditioning device according to claim 1, wherein:
the predetermined concentration is a second concentration;
a first concentration lower than the second concentration is determined in advance; and
the controller is configured to, when the controller receives the command to activate the compressor, activate the compressor when the gas concentration detected by the gas sensor is lower than the first concentration.

3. The in-vehicle air conditioning device according to claim 2, further comprising:
an internal temperature sensor configured to detect an internal temperature of the refrigerant circuit; and
an external temperature sensor configured to detect an external temperature of the refrigerant circuit,
wherein the controller is configured to
when the controller receives the command to activate the compressor, and the gas concentration detected by the gas sensor is higher than or equal to the first concentration and lower than or equal to the second concentration,
avoid the activation of the compressor when the temperature detected by the internal temperature sensor is lower than a temperature threshold, and activate the compressor when the temperature detected by the internal temperature sensor is higher than or equal to the temperature threshold, the temperature threshold being a value obtained by subtracting a predetermined temperature from the temperature detected by the external temperature sensor.

4. The in-vehicle air conditioning device according to claim 2, further comprising:
an internal pressure sensor configured to detect an internal pressure of the refrigerant circuit;
an external temperature sensor configured to detect an external temperature of the refrigerant circuit; and
a storage device storing a table representing a saturated vapor pressure curve of the refrigerant, wherein:
the controller is configured to acquire, by using the table of the saturated vapor pressure curve, a pressure of the refrigerant corresponding to the temperature detected by the external temperature sensor as an expected pressure; and
the controller is configured to
when the controller receives the command to activate the compressor, and the gas concentration detected by the gas sensor is higher than or equal to the first concentration and lower than or equal to the second concentration,
avoid the activation of the compressor when the pressure detected by the internal pressure sensor is lower than a pressure threshold, and activate the compressor when the pressure detected by the internal pressure sensor is higher than or equal to the pressure threshold, the pressure threshold being a value obtained by subtracting a predetermined pressure from the expected pressure.

5. The in-vehicle air conditioning device according to claim 1, wherein the controller is configured to stop the compressor when the gas concentration detected by the gas sensor increases and a rate of increase in the gas concentration per unit time becomes higher than a predetermined rate of increase while the compressor is in operation after the compressor is activated.
